(19) United States
(12) Patent Application Publication
(10) Pub. No.: US 2014/0164205 A1
(43) Pub. Date: Jun. 12, 2014

(54) MARKET ACCESS SYSTEM AND METHOD

(71) Applicant: Zomojo Pty Ltd, Sydney (AU)

(72) Inventor: Matthew Chapman, Coogee (AU)

(73) Assignee: Zomojo Pty Ltd, Sydney (AU)

(21) Appl. No.: 13/970,096

(22) Filed: Aug. 19, 2013

Related U.S. Application Data
(63) Continuation of application No. PCT/AU2012/000154, filed on Feb. 21, 2012.

(30) Foreign Application Priority Data
Feb. 21, 2011 (AU) 2011200733

(51) Int. Cl. G06Q 40/06

(52) U.S. Cl. CPC G06Q 40/06
USPC 705/37

(57) ABSTRACT

The present invention relates to a broker's market access system for use in processing orders for transmission to a market exchange. General purpose computing systems, with appropriate operating systems and application software typically implement broker's market access systems. In this invention, the market access system is implemented by dedicated hardware in the form of programmable logic devices, such as field programmable logic devices, for speeding processing of client orders. In an embodiment, the dedicated hardware comprises an architecture including order processing engines arranged to parallel process multiple client orders.

### FIELD OF THE INVENTION

The present invention relates generally to a market access system and, particularly, but not exclusively, to a market access system for processing and transmitting orders to a market exchange, such as a securities exchange.

### BACKGROUND OF THE INVENTION

Market trading systems, such as stocks and securities is exchanges, are well known. Much of interaction with market trading systems is carried out by market participants, such as brokers, who are arranged to receive orders from clients wishing to trade on the market exchange, process the orders to ensure that they are in the correct form, and transmit them onto the market exchange so that the orders can be transacted. In many jurisdictions, clients are not allowed to directly trade on the market exchange themselves, and must access the exchange via a licensed market participant such as a broker.

Nowadays, much market trading is done electronically. Brokers receive, via their “market access systems”, client orders electronically from client computers, and electronically forward those orders (after processing) to the market exchange. The market exchange is usually an automated exchange, such as an electronic securities exchange, arranged to receive specific trade requests, such as buy or sell orders for securities, stocks and other listed instruments (bonds, derivatives, etc). Each individual broker may have multiple clients who may wish to trade. The clients may wish to make many orders within a short period of time. This can lead to large volumes of orders from multiple clients, requiring processing and transmission to the market exchange.

In market trading, the speed of processing of orders by the broker (and also by the exchange) is extremely important. Two important factors in executing a trade are Price Priority and Time Priority. Price Priority means that the person who wishes to sell at the lowest price or wishes to buy at the highest price will be given priority in trade. Time Priority means that where there are two sellers or two buyers at the same price then the buyer or seller that reaches the market exchange first will (usually) execute first. Speed of processing is therefore critical.

A broker's clients will therefore desire that their order be processed and transmitted to the exchange with the least amount of delay (latency) possible. Hence the combination of a large number of client orders arriving simultaneously and client desire for timely order processing and retransmission require that the broker invest in information technology infrastructure in order to provide order processing latency and throughput acceptable to the clients. Latency refers to the delay a client's order is subjected to while it is being processed and retransmitted into the exchange by the broker. Throughput refers to the rate at which orders can be received from clients and the rate at which processed orders can be submitted to the exchange.

If the latency of a broker's system is too large, client orders will be late, and the broker's client risks missing preferred trading opportunities. Similarly, if the throughput of the broker's market access system is insufficient for the volume of orders being submitted by that broker's clients at any particular time, client orders will be delayed or discarded as they are queued for processing within the broker's market access system, with potential negative consequences for each client's trades. In either case (unacceptably high latency or unacceptably low throughput), the broker will be at a competitive disadvantage.

Currently, market access systems (for brokers and other market participants) are based on general purpose computing systems (GPCs), and typically executed on general purpose operating systems. The modular and layered nature of GPCs and the serial nature of order processing necessarily imposed by GPCs introduces latencies into order processing in the hundreds of microseconds at least, and typically milliseconds.

### SUMMARY OF THE INVENTION

In accordance with a first aspect, the present invention provides a market access system for transmitting market orders to a market exchange, comprising dedicated hardware arranged to receive and process client orders from clients, for forwarding to the market exchange.

In embodiments, the dedicated hardware may be a programmable logic device, such as a field programmable logic device, programmed for processing client orders. In an embodiment, the dedicated hardware may be an integrated circuit, such as a bespoke integrated circuit designed for processing client orders.

An advantage of at least embodiments of the invention is that dedicated hardware can process client orders at much faster speeds than GPCs. Latencies may be achieved in the low orders of microseconds and even nanoseconds.

In an embodiment, the dedicated hardware comprises an order processing engine arranged to process the client orders. The processing may comprise validation of client orders according to predetermined criteria. This may include determining if the incoming order message is not corrupted, is not in error, and can be successfully decoded into a valid client order. It may include confirming that the order can be executed by the broker, for example by confirming that the order makes logical sense, and complies with risk limits, rules and regulations laid down by the client, by the broker, by the exchange, or by any other regulatory authority. In an embodiment, the order processing engine is arranged to, wherever necessary, transform the client order so that it is in a format recognized by the exchange.

In an embodiment, a client order may comprise a plurality of portions, e.g. comprising a plurality of words. In an embodiment, the dedicated hardware is arranged to carry out processing on portions of an order as other portions of the order are still being received or are yet to be received. This has the advantage that processing speed is increased, as, unlike the case with GPC processing, it is not necessary to wait for the entire client order to be received before commencing processing.

In an embodiment, the dedicated hardware comprises a plurality of order processing engines, each arranged to process a corresponding plurality of orders in parallel. This has the advantage of further increasing the speed of processing. In an embodiment, each processing engine operates independently and concurrently with the other processing engines. In an embodiment, there are many order processing engines, resulting in massive parallel processing. This may be designed to result in very low latencies. In an embodiment there may be thousands of order processing engines.

In an embodiment, the dedicated hardware further comprises a transmit management arrangement which is arranged to receive orders that have been processed, for transmission to the market exchange. In an embodiment, the transmit management arrangement is arranged to order the processed orders in accordance with predetermined rules, for example predetermined business rules. For example, the transmit management arrangement may order the processed orders to prioritise clients over broker internal orders.

In an embodiment, the transmit management arrangement is arranged to start transmission of client orders before processing of the client orders has been completed. Portions of orders may be transmitted to the exchange while other portions of the same orders are still being processed. Advantageously, this further increases processing speed.

In an embodiment, the transmit management arrangement is arranged to receive a plurality of processed orders in parallel, and to arrange them so that they may be transmitted sequentially.

At least embodiments of the present invention have the advantage that the market access system exhibits low latencies and high throughput.

In accordance with a second aspect, the present invention provides a method of dealing with orders for transactions in a market exchange, comprising the steps of receiving the orders and processing them at hardware or close to hardware speeds, and transmitting the processed orders onto the market exchange.

In accordance with a third aspect, the present invention provides a transmitter for a market access system for transmitting client orders to a market exchange, the transmitter, comprising a transmit management arrangement arranged to transmit a portion of a client order while another portion of the client order is still being processed.

In accordance with a fourth aspect, the present invention provides a method of arranging orders for transmission to a market exchange, comprising the steps of receiving a portion of an order and transmitting the portion of the order while another portion or portions of the order are still being processed.

In accordance with a fifth aspect, the present invention provides a computer program, comprising instructions for controlling programmable hardware to implement a system in accordance with a first aspect of the present invention.

In accordance with a sixth aspect, the present invention provides a computer readable medium, providing a computer program in accordance with the fifth aspect of the present invention.

In accordance with a seventh aspect, the present invention provides a data signal, comprising a computer program in accordance with the fifth aspect of the present invention.

In accordance with an eighth aspect, the present invention provides a computer program, comprising instructions for controlling programmable hardware to implement a transmitter in accordance with the third aspect of the present invention.

In accordance with a ninth aspect, the present invention provides a computer readable medium, providing a computer program in accordance with the eighth aspect of the present invention.

In accordance with a tenth aspect, the present invention provides a data signal comprising a computer program in accordance with the eighth aspect of the present invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is a block diagram representing a system in accordance with an embodiment of the present invention, connected to client systems and also a market exchange;

FIG. 2 is a more detailed diagram of the system of FIG. 1, and

FIG. 3 is a flow diagram illustrating operation of the system of FIG. 1.

### DETAILED DESCRIPTION OF EMBODIMENTS

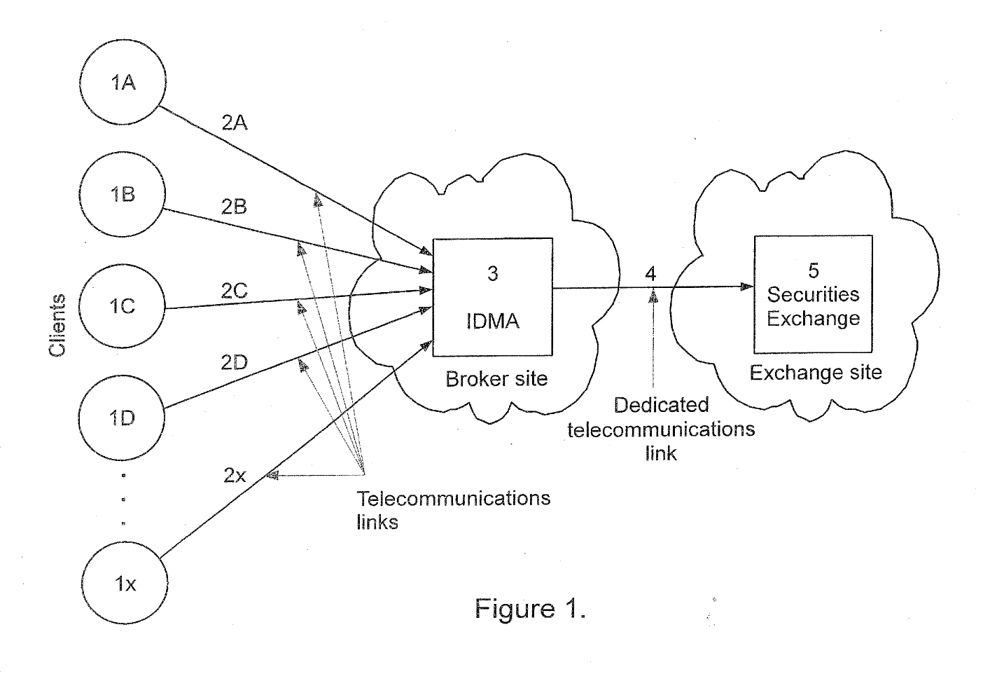

Referring to FIG. 1, a market access system in accordance with an embodiment of the present invention, generally designated by reference numeral 3, is shown in the form of an improved Direct Market Access (IDMA) system 3. In this embodiment, the DMA 3 is hosted or managed by a licensed market participant, in this case a broker.

The DMA 3 is arranged to receive client orders (in this embodiment from telecommunications channels 2A to 2x). The DMA 3 is arranged to receive and process the client orders and to forward the orders to a market exchange 5, which in this embodiment is a securities exchange for exchanging stocks and securities. In this embodiment, the processed orders are forwarded to the exchange 5 via a dedicated telecommunications link 4.

In this example, the client orders are provided from client computing systems 1A to 1x, of clients who wish to trade on the exchange 5. Clients may include individual traders, companies, accountants, and others. Other FPGAs or PGAs may be used.

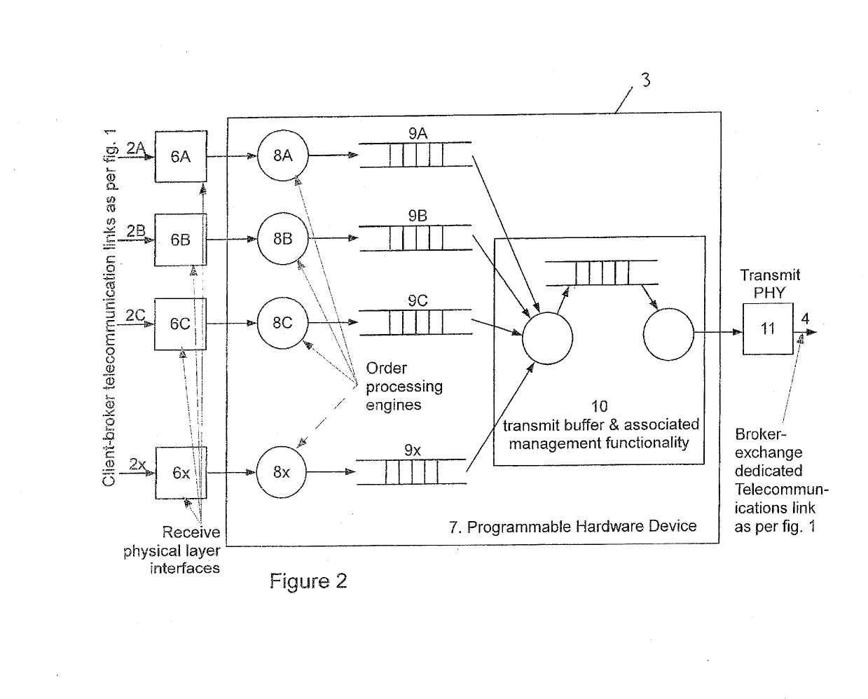

The DMA 3 comprises dedicated hardware, in this example embodiment being in the form of a programmable hardware is device 7 (see FIG. 2). This embodiment comprises Field Programmable Gate Arrays (FPGAs). The FPGA 7 may be a Xilinx Virtex 5′ FPGA.

In more detail, referring to FIG. 2, the architecture of the hardware device is arranged such that a plurality of client order engines 8A to 8x, are provided in parallel, each to receive and parallel process a plurality of client orders. In this embodiment, there may be one order processing engine for each client/broker link to 2A to 2x. There may be many (in the order of thousands) parallel order processing engines 8A to 8x. Each processing engine 8A to 8x operates independently and concurrently with all other processing engines; each processing engine 8A to 8x, is responsible for validating the contents of each client order received on the link 2A to 2x to which that processing engine is attached. Note that appropriate physical layer interfaces (PHY) 6A. to 6x receive the client orders from the links 2A to 2x. The PHY 6A to 6B carry out appropriate processing for managing a telecommunications interface, such as converting optical or electrical signals received on the links 2A to 2x into electrical voltages appropriate for processing within the FPGA 7.

Each client order engine 8A to 8x is arranged to validate the client order message. Validating may include checking order messages for correctness. That is, checking to determine if the incoming order message is not corrupted, is not in error, and can be successfully decoded into a valid client order. It may also confirm that the order can be executed by the broker, for example by confirming that the order makes logical sense, and complies with risk limits, rules and regulations laid down by the broker, by the exchange, or by any other regulatory authorities.

In one implementation, each order processing engine is implemented as a Finite State Machine (FSM), a concept which will be familiar to practitioners skilled in the art.

To validate, any business rules may be implemented by the order processing engine 8A to 8x.

A non-exhaustive list of some examples of various validation procedures which may be conducted by the order processing engines 8A to 8x is as follows:

### EXAMPLE 1

short selling prohibited Client A submits an order to sell 1,000 units of security with identifier XYZ at $100 per security sold. The order processing engines 206 determine that this transaction is a “short” sale. In certain markets, a “short” sale order is banned or limited, which in this case, the order is rejected, and the client is sent a notification of the rejection of his order with an electronic code that allows the client to determine the reason of the rejection.

### EXAMPLE 2

client risk limit exceeded Client B submits an order to buy 2,500 units of security with identifier XYZ at $12.56 per security bought. The order processing engines 206 determine that this order would cause a particular specified risk limit pertaining to this client to be exceeded. The order is rejected and the client is sent a notification of the rejection of his order with an electronic code that allows the client to determine the reason of the rejection.

### EXAMPLE 3

successful order processing Client C submits an order to buy 10,000 units of security with identifier XYZ-123 at $1.01 per security bought. The order processing engines 206 perform a number of checks, including, but not limited to:
   Checking that there a security with identifier XYZ-123 listed on the automated exchange to which the communication interface 106 is connected;
   Checking that no risk limits are breached if the order is fulfilled; and,
   Checking that the client is authorized to make the trade.

Other validation criteria than the above may be implemented.

The order processing engines 8A to 8x are also arranged to format the client orders into an appropriate form to be forwarded onto the exchange 5. This comprises converting (“re-encoding”) the order message from the format in which it is received into a format more appropriate for the exchange to which the order is to be forwarded. This might include the truncation of unnecessary information, or the transmission of the order in a different telecommunications technology to that on which the order was received (“bridging”). The output of an order processing engine 8A to 8x will typically be an order message in a format and encoding appropriate to being transmitted towards the exchange.

In this embodiment, the programmable hardware device 7 is programmed using a suitable computer language such as Very

High Speed Integrated Circuits Hardware Description Language (“VHDL”), C++ or assembler language to execute specific validation, formatting and any other processing.

An advantage of using a dedicated hardware device is that the overall processing architecture of the DMA can be optimized for efficient processing. Further; the parallel order engines facilitate rapid processing of multiple orders at once. These aspects facilitate greatly reduced latencies compared with GPC-based architectures. Another advantage includes ease of deployment in operational environments, such as a brokerage house, or implementation as a portable device.

Another aspect of each order processing engine 8A to 8x in this embodiment is that they are arranged to process a portion or portions of client orders as another portion or portions are being received or are yet to be received. The client order will generally comprise a plurality of instructions and data (usually in the form of digital words) arranged together in an order message. Instructions/data located early in the message can be validated and processed by an order processing engine 8A to 8x in this embodiment, before subsequent words have been received. It will be appreciated that this operation differs from the traditional “store and forward” approach of network communications equipment whereby an entire message must be received before it is processed and/or validated. This improvement results in further reducing order processing time and hence further reducing order latency, and also increasing throughput. This provides the broker a competitive advantage with respect to other brokers with prior art systems, and a consequent competitive advantage to clients wishing to trade on the exchange 5.

Referring to FIG. 2, each order processing engine 8A to 8x is directly attached to an outgoing message queue 9A to 9x. Once an order message has been processed by an order processing engine 8A to 8x, the output of the processing engine will be temporarily stored in the attached outgoing message queues 9A to 9x. Each outgoing message queue might be implemented within a programmable logic device using a construct known as “Dual-Port RAM” (or “DP RAM”).

Referring to FIG. 2, a transmit management arrangement 10 is used to temporarily store order messages received from the outgoing message queues 9A to 9x and also to process them into a particular order, depending upon predetermined criteria which may include business rules. The orders are stored until they are transmitted towards the exchange 5 via physical layer interface PHY 11 and dedicated telecommunications link 4. In this embodiment, the management functionality associated with the transmit buffer 10 is responsible for taking processed client orders from each outgoing message queue 9A to 9x and arranging them according to a defined priority scheme. They are then copied into the transmit buffer in order to be transmitted towards the exchange. The priority scheme may treat particular types of orders with higher priority than other types of orders. Any criteria may be applied. The transmit buffer 10 operates to aggregate the processed orders into a serial arrangement for on transmission to the exchange.

In this embodiment, the transmit buffer 10 has the ability to immediately begin transmitting portions of a client order produced by any order processing engine if there are no orders queued in the transmit buffer 10. Client orders are only stored in the transmit buffer 10 if the combined rate of client orders arriving from all clients exceeds the capacity of the buffer exchange link 4 to transmit them.

In other words, this allows portions of order messages to be processed and transmitted “on the fly” as other portions of the message are still being processed. This advantageously increases throughput and lowers latency.

The integration of the order processing engines 8A to 8x, the outgoing message queues 9A to 9x; the transmit buffer 10, is such that transmission of a client order towards the exchange on the broker exchange link 4 may commence as soon as the order processing engine begins to produce the outgoing message. This may result in the early portion of a client order being transmitted towards the exchange while the latter portion of the order message is still being processed by an order processing engine.

The transmit PHY 11 is a component of the process of transmitting the order message along the broker exchange telecommunication link 11. The transmit PHY 11 accepts order messages from the programmable device 7 as electrical signals, converts the electrical voltages representing the order message within the programmable hardware device into the appropriate physical form for transmission to the exchange via the dedicated broker exchange telecommunication link 4 and transmits them across the link to the exchange 5. The order message may be converted into electrical, optical, radio/electromagnetic signals, or any suitable physical form for transmission.

In this embodiment, the transmit buffer module 10 is also implemented in the programmable hardware device.

In one example, the function of aggregating the orders is arranged to combine certain order information into a suitable combination which will result in a more effective or profitable execution by the exchange 5. For example, where multiple orders from different clients relate to a specific security or stock, the order information received from the different clients may be combined to form a single order to minimize costs to execute the transaction or to increase the speed of the transaction. Other more complex rules can be implemented as part of this aggregation function including, but not limited to, recognition of hedging, risk assessment, index or indices tracking or exploitation of arbitrage opportunities.

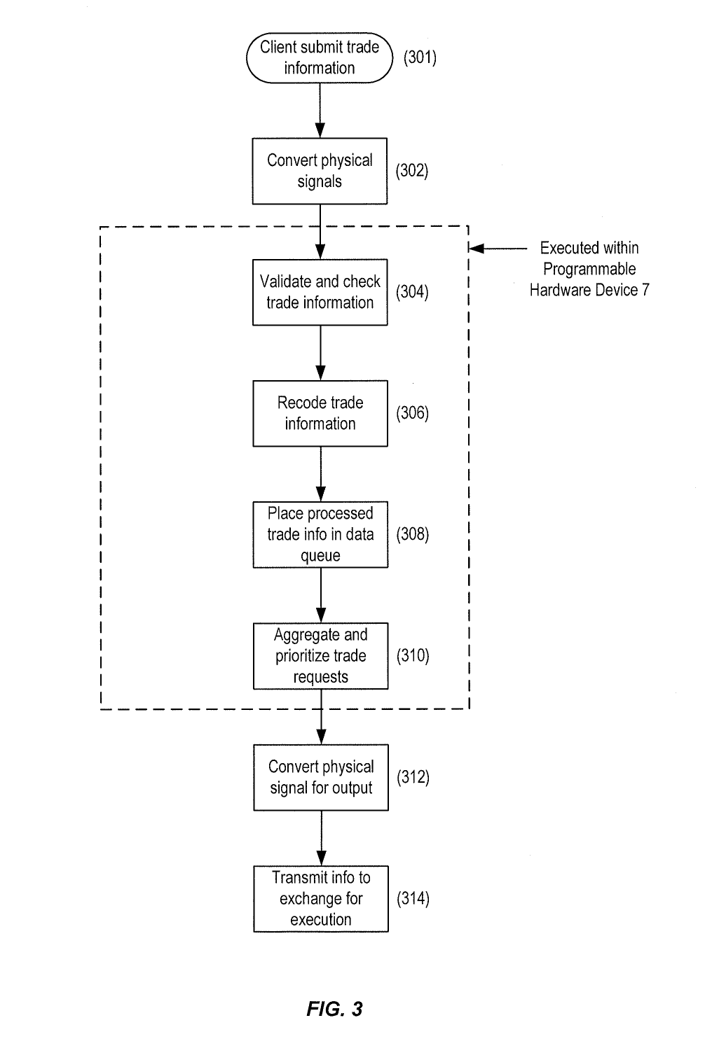

Referring to FIG. 3, a flow diagram of the operation of an embodiment of the DMA 3 is shown. Multiple clients are connecting via telecommunications link 2A to 2x (WAN, LAN or telephone). The clients 1A to 1x may submit their desired trade requests to the broker to arrange for their requests to be executed by the securities exchange 5 (step 301).

At step 302, each physical layer interface 6A to 6x connects to each individual client and operates concurrently to convert the physical signals of the client's order into a suitable format for input into the programmable hardware device 7.

Once the conversion step 302 is completed, the order is then processed by each processing engine 8A to 8x (304) to validate the order for correctness and compliance with regulations. If the processing engines 8A to 8x deem the received trade information as valid, the processing engines 8A to 8x proceed to recode (306) the trade information into a suitable data format for the exchange 5.

After the recoding process, (306) is completed, the information is temporarily stored in the data queues 9A to 9x (308) to wait for further processing by the transmit buffer 10.

The transmit buffer 10 then arranges to aggregate and prioritize the trade information (310) and when suitable proceeds to transmit the trade information to a second physical layer interface PHY11. The second physical layer interface 11 then converts the order into suitable transmission form and proceeds to transmit these signals to the automated exchange 5 for execution (314).

The following is an example of order processing which might be implemented by an embodiment of the present invention, utilizing example messages.

### ORDER PROCESSING EXAMPLE

The order processing engine 8x in the IDMA 3 (implemented by FPGAs in this embodiment) in FIG. 2 is designed so as to operate synchronously with network reception. For a Gigabit Ethernet network, an FPGA clock rate of 125 Mhz is desirable, which allows 8 bits (one byte) of data to be received and processed every clock cycle.

There are two types of ECN messages processed by the FPGA 3 in this example: a new order message, and a modify/cancel order message. The ECN messages are encapsulated in standard Internet Protocol (UDP/IP) packets. An example new order message is as follows:

| | |
|---|---|
| Ethernet protocol header | 112 bits/14 bytes |
| IP protocol header | 160 bits/20 bytes (minimum) |
| UDP protocol header | 64 bits/8 bytes |
| — | |
| Session ID | 16 bits/2 byte |
| Sequence Number | 16 bits/2 bytes |
| Instrument Code | 32 bits/4 bytes |
| Message Type | 8 bits/1 byte (0 = NEW ORDER) |
| Transaction Type | 8 bits/1 byte (0 = buy, 1 = sell) |
| (Reserved for Future Use) | 16 bits/2 bytes |
| Quantity | 16 bits/2 bytes |
| Price | 16 bits/2 bytes |
| Client Reference | 32 bits/4 bytes |

Firstly, the Ethernet, IP and UDP protocol headers are skipped; this is fairly straight-forward, although the IP header can be variable-length.

Then the ECN protocol fields are received.

The first field—the Session ID—is an opaque token that represents the session between a client and the exchange. Utilising this first field, data related to the client can be looked up in a client information array stored in the FPGA. When the Sequence Number field is received, the FPGA then verifies that the sequence number matches the expected sequence number for the client. If this check fails the rest of the message is ignored and a notification message is immediately returned to the client. Otherwise, the expected sequence number is incremented by one in preparation for the next message, and processing proceeds. The Session ID is transformed into a more compact “client index” identifying the client, and these two fields are otherwise discarded.

The following four bytes indicate the Instrument Code that the message relates to. This might be a stock code such as “MSFT”, or some other identifier. The FPGA, using efficient look-up tables (LUTs), determines if the instrument code is valid. If so, it transforms it into a more compact form, namely an instrument index. Such a form makes later processing much more efficient, but this number may only be ephemerally valid, whereas it is desirable for clients to use a standard instrument code.

Other fields in the message convey the Transaction Type (buy or sell), Price, Quantity, and Client Reference (a client-supplied field that is sent to the client in any correspondence about an order). As each of the remaining fields is received, an internal representation is constructed; as per the schema below. Many of the input fields can be passed through verbatim. However, some validation is performed on the fields to ensure that they have reasonable values; for instance, that the Transaction Type is either buy or sell. This ensure that only well-formed messages will be sent to the securities exchange. Some fields, such as the Reserved field, are in the protocol only for future expansion, and can be omitted from the internal form.

Once all of the fields have been received, an internal sequence number is appended. The resulting 16-byte internal record is written to a circular buffer in a memory area that is shared with the market transmission functionality.

| | |
|---|---|
| Client Index | 1 byte |
| Instrument Index | 1 byte |
| Message Type | 1 byte (0 = NEW ORDER) |
| Transaction Type | 1 byte (0 = buy, 1 = sell) |
| Quantity | 2 bytes |
| Price | 2 bytes |
| Client Reference | 4 bytes |
| (Unused) | 2 bytes |
| Internal Sequence Number | 2 bytes |

Similar processing is also applied to the modify/cancel message:

| | |
|---|---|
| Ethernet protocol header | 112 bits/14 bytes |
| IP protocol header | 160 bits/20 bytes |
| UDP protocol header | 64 bits/8 bytes |
| — | |
| Session ID | 16 bits/2 bytes |
| Sequence Number | 16 bits/2 bytes |
| Instrument | 32 bits/4 bytes |
| Message Type | 8 bits/1 byte |
| | (1 = MODIFY/CANCEL ORDER) |
| (Reserved for Future | 8 bits/1 byte |
| Use) | |
| New Quantity | 16 bits/2 bytes |
| Order Reference | 32 bits/4 bytes |
| Client Reference | 32 bits/4 bytes |

This message contains similar fields to the new order message and is processed similarly. Instead of the Transaction Type and Price, an Order Reference is used to refer to the order that was placed. This is placed verbatim into the 16-byte internal record, which in this case appears as follows:

| | |
|---|---|
| Client Index | 1 byte |
| Instrument Index | 1 byte |
| Message Type | 1 byte (1 = MODIFY/CANCEL ORDER) |
| (unused) | 1 byte |
| Order Reference | 4 bytes |
| Client Reference | 4 bytes |
| New Quantity | 2 bytes |
| Internal Sequence Number | 2 bytes |

Market message formats

Once an order is deemed valid it is encoded into a form understood by the specific securities exchange depicted as 5 in FIG. 1.

When orders or partial orders are executed at the securities exchange notification messages are received and parsed in anticipation of notifying the client from whom the order was originally received.

A notification engine in the FPGA reads records from the notification queue and sends messages to clients. The client index is used to index into a client information array, which contains the Ethernet address, IP address and UDP port number to use to contact the client, as well as the next outgoing sequence number. The internal instrument index is mapped back into the 4-byte instrument code used by clients. Other fields are conveyed verbatim.

The outgoing messages are generated by FPGA logic which executes synchronously with network transmission, generating each output byte as required rather than needing a pre-constructed message in memory. Fields from the notification record are substituted into the outgoing message in appropriate slots. An example of an outgoing message is as follows:

| | |
|---|---|
| Ethernet protocol header | 112 bits/14 bytes |
| IP protocol header | 160 bits/20 bytes |
| UDP protocol header | 64 bits/8 bytes |
| — | |
| Sequence Number | 16 bits/2 bytes |
| Notification Type | 8 bits/1 byte |
| Transaction Type | 8 bits/1 byte |
| Instrument Code | 32 bits/4 bytes |
| Quantity | 16 bits/2 bytes |
| Price | 16 bits/2 bytes |
| Client Reference | 32 bits/4 bytes |
| Order Reference | 32 bits/4 bytes |

It will be appreciated that the messages included in the above description are examples only, and messages of other formats or other messages may be processed by arrangements in accordance with other embodiments of the present invention.

In an embodiment, a system such as the embodiment described above may be reproduced a number of times in order to effect redundancy. It will be appreciated that redundancy in a system such as this may be important in order to ensure that market trading can continue (in the event of the breakdown of part or whole of the system) and that trading records are maintained.

In the above embodiment, the communication architecture includes parallel transmission channels into the hardware device and a single transmission channel out of the hardware device with appropriate physical layer interfaces. The invention is not limited to this, and any appropriate architecture for transmission may be applied, including a network architecture (Internet), wireless architecture or any other architecture. Further, parallel telecommunications channels out to the exchange may be provided in some circumstances.

In the above embodiment, the DMA is providing orders to a securities exchange for trading in stocks, shares, other securities. The invention is not limited to this. Embodiments may communicate with other types of exchanges, or any market.

In the above embodiment, the exchange that the DMA is transmitting the processed orders to is a fully automated exchange (ATS). The invention is not limited to this, and the exchange may be partly automated or may be any type of exchange that can receive the signals from the DMA.

In the above embodiment, a programmable hardware device used to implement the DMA is a FPGA. The invention is not limited to this, the DMA may be implemented by any dedicated hardware, including programmable logic devices, application specific integrated circuits, or any other dedicated hardware.

In the above embodiments, elements such as the order processing engines 8A to 8x and data queues 9A to 9x may be implemented as logical constructs utilizing appropriate programming. For example, by writing VHDL code, C/C++, System C code, by creating schematic or state transition diagrams, or any other method for expressing a design for a programmable hardware device, which is then used to program the programmable logic device.

Where program code is utilized to configure a programmable logic device, such as an FPGA, for example, it will be appreciated that the program code could be supplied in a number of ways. For example, on a computer readable medium, such as a disk or a memory, as a data signal (for example, by downloading it from a server), or in any other way.

In the above embodiment, the order processing engines and transmit management arrangement are implemented in dedicated hardware. The invention is not limited to this. Parts of the DMA may be implemented in dedicated hardware and other parts on a GPC, for example. This may be convenient in some circumstances. For example, order processing could be implemented by a GPC and dedicated hardware used for the transmit management arrangement, still giving some increase in speed and throughput. The arrangement could be reversed, a GPC being used as the transmit management arrangement and dedicated hardware for the order processing engines.

In the above embodiment, validation, coding, formatting and aggregation functions are implemented. All these functions may be implemented in other embodiments. In other embodiments, some, one or all of the functions may be implemented.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be understood to persons skilled in the art of the invention that many modifications may be made without departing from the spirit and scope of the invention.

1-30. (canceled)

31. A market access system for transmitting market orders to a market exchange, comprising dedicated hardware arranged to receive and process client orders from clients, for forwarding to the market exchange.

32. A system in accordance with claim 31, wherein the dedicated hardware comprises an order processing engine arranged to process the client orders.

33. A system in accordance with claim 32, wherein the order processing engine is arranged to validate client orders according to validation criteria.

34. A system in accordance with claim 32, wherein the order processing engine is arranged to format the client orders into an appropriate form to be forwarded on to the market exchange.

35. A system in accordance with claim 32, wherein the client order comprises a plurality of portions, and the order processing engine is arranged to process a portion or portions of the client order as another portion or portions are being received or are yet to be received.

36. A system in accordance with claim 32, wherein the dedicated hardware comprises a plurality of the order processing engines, each order processing engine being arranged to operate in parallel so as to parallel process a plurality of client orders.

37. A system in accordance with claim 32, wherein the dedicated hardware further comprises an outgoing message queue associated with each order processing engine, and arranged to receive a processed order for temporary storage and on forwarding to the market exchange.

38. A system in accordance with claim 31, further comprising a transmit management arrangement, which is arranged to receive the processed orders for transmission to the market exchange.

39. A system in accordance with claim 38, wherein the transmit management arrangement is arranged to order the processed orders for transmission, in accordance with predetermined rules.

40. A system in accordance with claim 38, wherein the transmit management arrangement is arranged to aggregate a plurality of processed orders for transmission to the securities exchange.

41. A system in accordance with claim 38, wherein the transmit management arrangement is arranged to transmit a portion or portions of an order whilst another portion or portions of the order are being processed or are yet to be processed.

42. A system in accordance with claim 38, wherein the transmit management arrangement comprises a buffer arranged to store processed orders for transmission.

43. A system in accordance with claim 38, wherein the transmit management arrangement is arranged to receive processed orders in parallel and to serially arrange them for transmission to the securities exchange.

44. A system in accordance with claim 38, wherein the transmit management arrangement comprises dedicated hardware.

45. A system in accordance with claim 31, wherein the dedicated hardware is a programmable logic device programmed for processing of the client orders.

46. A system in accordance with claim 45, wherein the dedicated hardware is a programmable gate array.

47. A system in accordance with claim 46, wherein the dedicated hardware is a field programmable gate array.

48. A method of dealing with orders for transactions in a market exchange, comprising the steps of receiving the orders and processing them at hardware or close to hardware speeds, and transmitting the processed orders onto the market exchange.

49. A method in accordance with claim 48, wherein the step of processing the orders comprises processing a plurality of the orders in parallel.

50. A method in accordance with claim 48, wherein the step of processing the orders comprises processing a portion or portions of the order whilst another portion or portions of the order are still being received or are still to be received.

51. A method in accordance with claim 48, comprising the step of transmitting the portion or portions of the order while another portion or portions of the order are still being processed or are yet to be processed.

52. A method of arranging client orders for transmission to a market exchange, comprising the steps of receiving a portion or portions of the client order and transmitting a portion or portions of the client order while another portion or portions of the order are still being received.

53. A method in accordance with claim 52, wherein the step of receiving the client order comprises the step of receiving a plurality of client orders simultaneously or near to simultaneously, in a parallel format, and processing them into a sequential format for transmission.

54. A computer readable medium, comprising instructions for controlling a computer to implement a system in accordance with claim 31.
